(19) United States
(12) Patent Application Publication
(10) Pub. No.: US 2011/0242016 A1
(43) Pub. Date: Oct. 6, 2011

(54) TOUCH SCREEN

(75) Inventor: YU-CHIH PENG, Taoyuan (TW)

(73) Assignee: FOXCONN COMMUNICATION TECHNOLOGY CORP., Taoyuan County (TW)

(21) Appl. No.: 12/900,681

(22) Filed: Oct. 8, 2010

(30) Foreign Application Priority Data
Mar. 30, 2010 (TW) 99109681

(51) Int. Cl. G06F 3/041; G09G 5/00

(52) U.S. Cl. 345/173; 345/1.3

(57) ABSTRACT

A touch screen includes a touch unit, a driver integrated circuit (IC), and a processor unit. The touch unit includes a plurality of touch members, and each touch member is a single-touch screen. The driver IC is electrically connected to all the touch members. The processor unit is electrically connected to the driver IC and all the touch members. The processor unit controls all the touch members to cooperatively display a menu or other image using the driver IC. Each touch member independently generates an indicating electric signal when it is touched, the processor unit detects the touched parts of all touched touch members according to the indicating electric signals, thereby detecting options selected in the menu corresponding to the touched parts of all touched touch members and performing the detected options.

### BACKGROUND

1. Technical Field

The present disclosure relates to touch screens, and particularly to a touch screen capable of being used in both a single-touch mode and a multi-touch mode.

2. Description of Related Art

Touch screens are widely used in portable electronic devices, such as mobile phones, personal digital assistants (PDA), and laptop computers, etc. At first, most touch screens were single-touch screens. A single-touch screen is limited in function by the fact it can only detect the position of one touch at a time. Recently multi-touch screens have been introduced that can detect more than one touch simultaneously thus greatly improving functionality of touch screens. However, multi-touch screens have complicated structures and are expensive.

Therefore, there is room for improvement within the art.

### BRIEF DESCRIPTION OF THE DRAWINGS

Many aspects of the present touch screen can be better understood with reference to the following drawings. The components in the various drawings are not necessarily drawn to scale, the emphasis instead being placed upon clearly illustrating the principles of the present touch screen. Moreover, in the drawings, like reference numerals designate corresponding parts throughout the figures.

FIG. 1 is a schematic view of a touch screen, according to an exemplary embodiment.

FIG. 2 is a block diagram of the touch screen shown in FIG. 1.

### DETAILED DESCRIPTION

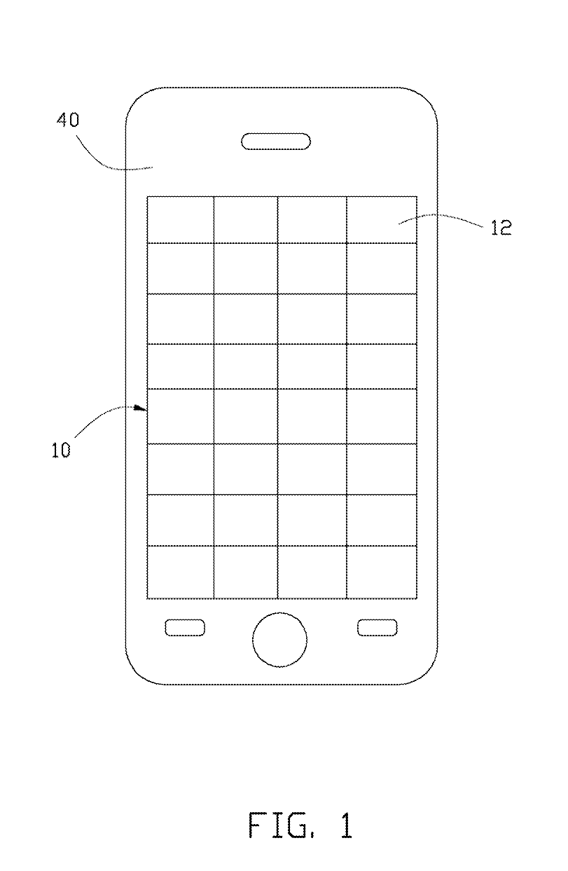

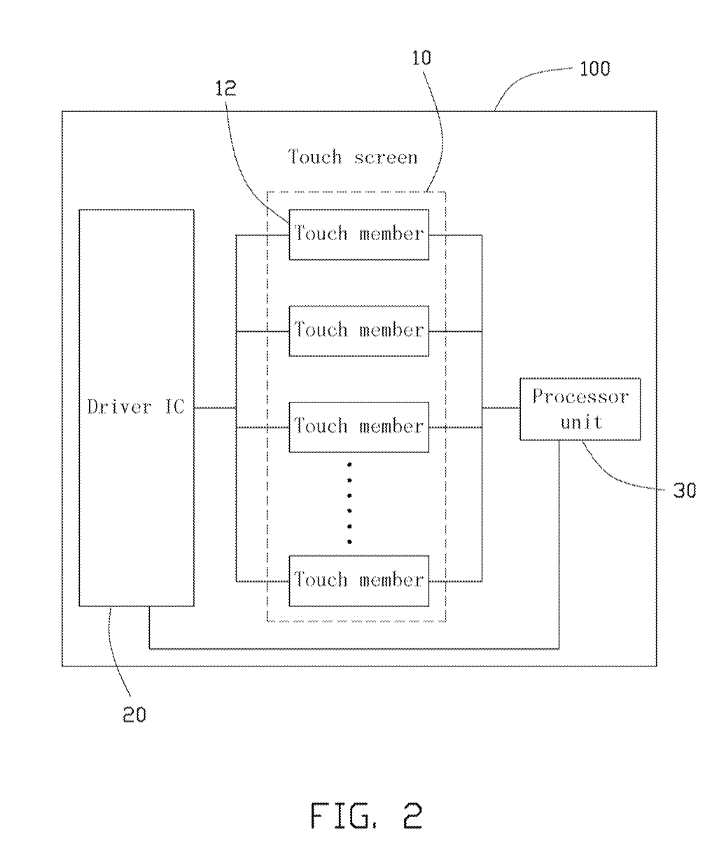

FIG. 1 schematically shows a touch screen 100, according to an exemplary embodiment. The touch screen 100 can be used in a portable electronic device (not shown), such as a mobile phone, a personal digital assistant (PDA), etc. Also referring to FIG. 2, the touch screen 100 includes a touch unit 10, a driver integrated circuit (driver IC) 20, a processor unit 30, and a housing 40. The housing 40 can be integral with the housing of the portable electronic device. The touch unit 10, the driver IC 20, and the processor unit 30 are all received in the housing 40 and are electrically connected in series.

The touch unit 10 is a multiple screen, which includes a number of touch members 12 arranged closely. Each touch member 12 is a single-touch screen, and all touch members 12 are independent from each other. Particularly, the touch members 12 can be capacitive touch screens, resistive touch screens, or other conventional touch screens. When a touch member 12 is touched by an operation member (not shown), such as a finger or a stylus, it can detect the touched part thereof and generate an indicating electric signal corresponding to the touched part. The area of each touch member 12 is configured to be small enough so that more than one operation member cannot touch the same touch area simultaneously.

The driver IC 20 is electrically connected to all the touch members 12 and controls all the touch members 12 to synchronously function for cooperatively displaying images. When the touch screen 100 displays an image, the driver IC 20 detects particular positions of all the touch members 12, and synchronously drives all the touch members 12 to respectively display parts of the image corresponding to their positions, such that all the touch members 12 cooperatively display the image.

The processor unit 30 can be integrated with the central processing unit (CPU) of the portable electronic device. All the touch members 12 are electrically connected to the processor unit 30. When any touch member 12 is pressed, indicating electrical signals are generated corresponding to their touched parts, and the processor unit 30 can detect the positions of the touched touch members 12 and their touched parts according to the indicating electric signals. The driver IC 20 is also electrically connected to the processor unit 30, such that the processor unit 30 can detect particular positions of all the touch members 12 and control all the touch members 12 to cooperatively display images using the driver IC 20.

When the touch screen 100 is used, one or more operation members may be used. Correspondingly, the touch screen 100 has a single-touch mode and a multi-touch mode. In both the single-touch mode and the multi-touch mode, the processor unit 30 first detects particular positions of all the touch members 12 and uses the driving IC 20 to synchronously control all the touch members 12 to respectively display parts of a current image such as a menu corresponding to their positions. Thus, all the touch members 12 cooperatively display the menu.

In the single-touch mode, only one touch of an operation member (not shown), such as a finger or a stylus, is detected on the touch unit 10 to select an option in the menu. The touch member 12 pressed by the operation member generates an indicating electric signal corresponding to its touched part. The processor unit 30 detects the position of the touched touch member 12 and the touched part thereof according to the indicating electric signal, and then compares the position of the touched touch member 12 and the touched part thereof with the currently displayed image to detect selected option. Thus, the processor unit 30 performs the selected option.

In the multi-touch mode, one or more touches by one or more operation members can be detected simultaneously on the touch unit 10 to allow simultaneous selection of one or more options in the menu. The touch members 12 pressed by the operation member respectively independently generate indicating electric signals corresponding to their touched parts. The processor unit 30 simultaneously detects the positions of the touched touch members 12 and the touched parts thereof according to the indicating electric signals, and then compares the positions of the touched touch members 12 and the touched parts thereof with the currently displayed menu to determine selected options. Thus, the processor unit 30 can simultaneously perform all the selected options, and can also orderly perform the selected options according to a predetermined order. Since the area of each touch member 12 is small, the touch screen 100 prevents more than one operation member simultaneously contacting a same touch unit 12. Thus, each touch unit 12 has at most one touched part, and therefore can precisely detect the position of the touched part in use.

Furthermore, the touch screen 100 can be used to input instruction to the portable electronic device by writing. In the single-touch mode, an operation member (not shown) contacts the touch unit 10 and moves on the touch unit 10, and a plurality of touch members 12 are orderly touched by the moving operation member. Correspondingly, the touched touch members 12 generate a sequence of indicating electrical signals. The processor unit 30 receives the indicating electric signals in sequence. Thus, the processor unit 30 can determine a pattern of the touch input and interpret the input once completed as written input. In detail, when the operation member stops moving on the touch unit 10, the processor unit 30 compares the positions of the touched touch members 12 and the touched parts thereof with the currently displayed menu or other image to obtain the moving trace of the operation member formed on touch unit 10. The moving trace of the operation member is input to the portable electronic device as handwriting.

In the multi-touch mode, if more than one operation members contact the touch unit 10 and move on the touch unit 10, the processor unit 30 can simultaneously detect moving traces of all the operation members as detailed above, and use the moving traces as written input to the touch screen 100. Thus, more than one operation member can be used to respectively input written instructions to the touch screen 100.

The present touch screen 100 uses a number of single-touch screens (i.e., the touch members 12) to cooperatively display images such as menus, and the touch members 12 can respectively independently generate indicating electric signals corresponding to their touched parts. Thus, the touch screen 100 can simultaneously detect more than one operation members respectively contacting different touch members 12, and thus can be used as a multi-touch screen. Furthermore, since all the touch members 12 are single-touch screens, the touch screen 100 does not need to use conventional multi-touch screens to serve as the touch unit 10 or the touch members 12. Compared with conventional multi-touch screens, the touch screen 100 has a simpler structure and costs less.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, area, and arrangement of parts within the principles of the present invention to the full extent indicated by the broad general meaning of the terms in which the appended claims are expressed.

What is claimed is:

1. A touch screen, comprising:
a touch unit including a plurality of touch members, each touch member being a single-touch screen;
a driver integrated circuit (IC) electrically connected to all the touch members; and
a processor unit electrically connected to the driver IC and all the touch members; wherein the processor unit controls all the touch members to cooperatively display a same image using the driver IC; each touch member independently generating an indicating electric signal when it is touched, the processor unit detecting the touched parts of all touched touch members according to the indicating electric signals, thereby detecting options in the image corresponding to the touched parts of all touched touch members and performing the detected options.

2. The touch screen as claimed in claim 1, wherein all the touch members are arranged closely to form a multiple screen.

3. The touch screen as claimed in claim 2, wherein the driver IC detects positions of all the touch members and synchronously drives all the touch members to respectively display parts of the image corresponding to their positions, such that all the touch members cooperatively display the image.

4. The touch screen as claimed in claim 1, wherein when more than one touch members are touched and generate corresponding indicating electric signals, the processor unit simultaneously detects selected options in the image corresponding to the touched parts of all the touched touch members according to the indicating electric signals, and simultaneously performs all the selected options in the image corresponding to the touched parts.

5. The touch screen as claimed in claim 1, wherein when more than one touch members are touched and generate corresponding indicating electric signals, the processor unit simultaneously detects selected options in the image corresponding to the touched parts of all the touched touch members according to the indicating electric signals, and performs all the selected options in the image corresponding to the touched parts according to a predetermined order.

6. The touch screen as claimed in claim 1, wherein when an operation member contacts and moves on the touch unit, the processor unit detects the moving trace of the operation member formed on touch unit according to the indicating electric signals generated by the touch members contacted by the operation member, and uses the moving trace of the operation member as an input handwriting.

7. The touch screen as claimed in claim 1, wherein when more than one operation member contact and move on the touch unit, the processor unit simultaneously detects the moving traces of the operation members formed on touch unit according to the indicating electric signals generated by the touch members contacted by the operation members, and uses the moving traces of the operation members as input handwritings.
